(19) United States
(12) Patent Application Publication
(10) Pub. No.: US 2016/0245018 A1
(43) Pub. Date: Aug. 25, 2016

(54) ROLLER SHADE WITH A BRAKE

(71) Applicant: Domicet Oy, Kaarina (FI)

(72) Inventor: Lasse Pohjonen, Paimio (FI)

(21) Appl. No.: 14/626,407

(22) Filed: Feb. 19, 2015

(51) Int. Cl. E06B 9/80; E06B 9/68; E06B 9/60

(52) U.S. Cl. CPC E06B 9/80; E06B 9/60; E06B 9/68

(57) ABSTRACT

The roller shade is wrapped around a shaft tube which has a supporting member through which the roller shade can be fastened to the wall or the like. The roller shade also includes a spring mechanism, with which the roller shade can be lowered upon tensioning of an un-wrap spring fitted around the shaft that rotates in a first direction at the lowering and be raised upon releasing of the un-wrap spring when the shaft rotates in the opposite direction. The roller shade is mainly characterized by an eddy current brake fastened to the shaft for a controlled release of the tensioning of the spring.

### TECHNICAL FIELD The invention is concerned with a roller shade that can be lowered upon tensioning of an un-wrap spring and raised upon releasing of the un-wrap spring.

### BACKGROUND

Roller shades also called roller blinds are characterized by a lifting mechanism, with which the curtain part of the shade can be raised in an upper position and be lowered to a lower position. The most common type of lifting mechanism is a chain mechanism on one side of the shade. The chain mechanism includes a chain loop by means of which the roller shade can be wound up around a roll and be unwound again.

Such chain loops as well as different ropes and strings can, however, cause a risk of choking for children that might place their head through the loop.

Different accessories can be used to keep the ropes and strings unavailable for children or the minimizing of the risk can otherwise be taken into consideration in the product design.

Such “safe by design” products are roller shades that are equipped with an electric motor or a spring mechanism for the winding.

Winding mechanisms of the latter type are well known and frequently used. A spring is tensioned when the shade is pulled down and a latching device blocks the roller shade at desired adjustments. The force of the spring is at its maximum when the tube around which the shade is rolled up has to carry the largest length of hanging shade. When the latching device is freed by means of a sharp pull in the shade, the roller shade is wound around the tube during a strong acceleration.

A problem in connection with roller shades having a spring mechanism is that the shade is raised up without any control with a high speed when the spring is released and could damage the shade and its support members as well as other parts of the roller shade. The shade could also be jammed between the wall and the shaft roll or be wound around the roll until complete release of the spring. In all these cases the release caused a hard collision and sound.

Different attempts have been made to facilitate the use of the spring rollers by connecting a brake there to that slows down the speed of the shade when the spring force is released in the lower position of the shade.

Such decelerating brake mechanisms are usually realized either with a mechanical friction brake or with hydraulic means. Both these solution, however, involve some problems.

In friction brakes, the problem is the abrasion of the brake shoes that usually are made of plastic and the sound of the braking.

Hydraulic brakes in turn have problems with the oil used inside and its properties in changing temperatures, i.e. the oil should stay inside the enclosed brake also in high temperature but should not brake too much or solidify in cold conditions.

European patent 1 893 841 is mentioned as prior art for a mechanical solution for fine adjustment of roller blinds by using a manually rotatable control element that engages an un-wrap spring in order to loosen it, whereby the roller blind becomes un-coupled from the drive shaft. The rotation of the control element also turns for fine adjustment in the same movement.

European patent 1 009 904 also discloses a solution for a controlled raising and stopping of a roller blind being an example of the above mentioned friction brake use.

The Canadian patent application 2 660 914, in turn, discloses an improved roller blind clutch assembly for controlling the raising and lowering of a roller blind.

US patent application US2014/0196857 is an example of a friction brake solution for a roller shade control system.

The object of the invention is a new alternative for a brake mechanism for retarding the raising speed of a roller shade, which works in all conditions and does not contain abrasive brake parts.

### SUMMARY OF THE INVENTION

The roller shade of the invention is wrapped around a shaft tube, which has a supporting member through which the roller shade can be fastened to the wall or the like. The roller shade also includes a lifting mechanism, with which the roller shade can be lowered upon tensioning of an un-wrap spring fitted around the shaft that rotates in a first direction at the lowering and be raised upon releasing of the un-wrap spring when the shaft rotates in the opposite direction. The roller shade is mainly characterized by an eddy current brake fastened to the shaft for a controlled release of the tensioning of the spring.

Thus, the invention is a based on a roller shade that can be raised and lowered by spring force with a lifting mechanism. It has a support member that can be fastened with fastening means to the window frame, wall or the like. The lifting mechanism of the roller shade is a spring mechanism in which a spring becomes tensioned when the roller shade is lowered. The spring force is higher the lower the shade is drawn down. The spring mechanism is locked when the down drawing (the lowering) is stopped but the tension developed in the spring remains. The roller shade includes latching devices with which the roller shade can be locked in a desired lowered position. The locking is mechanically realized by means of small balls in such a way that the ball stays in the outer periphery of the spring mechanism when the shade is drawn downwards and when the drawing is stopped the ball falls down into a cavity in an end piece of the spring mechanism and locks the mechanism. By drawing the further downwards a little, the spring can be released again and the shade is raising by means of the accumulated force. If the roller shade is allowed to raise freely like in some prior art solutions, the speed is accelerated and the shade raises too strongly by colliding with the support members of the shade or by jamming between the wall and the shaft tube or by rolling around the shaft until the spring is completely released. In all these cases, the raising results in a hard collision and a loud sound and the shade can be damaged.

By using a brake mechanism that is based on magnetism as in the solution of the invention, the shade can be raised evenly, quiet and soundless to the upper position. An eddy current brake is a preferred solution to be used in the roller shade of the invention.

An eddy current brake, like a conventional friction brake, is a device used to slow or stop a moving object by dissipating its kinetic energy as heat. However, unlike electro-mechanical brakes, in which the drag force used to stop the moving object is provided by friction between two surfaces pressed together, the drag force in an eddy current brake, is an electromagnetic force between a magnet and a nearby conductive object in relative motion, due to eddy currents induced in the conductor through electromagnetic induction.

A conductive surface moving past a stationary magnet will have circular electric currents called eddy currents induced in it by the magnetic field, due to Faraday's law of induction. By Lenz's law, the circulating currents will create their own magnetic field which opposes the field of the magnet. Thus the moving conductor will experience a drag force from the magnet that opposes its motion, proportional to its velocity. The electrical energy of the eddy currents is dissipated as heat due to the electrical resistance of the conductor.

In an electromagnetic brake the magnetic field may be created by a permanent magnet, or an electromagnet so the braking force can be turned on and off or varied by varying the electric current in the electromagnet's windings. Another advantage is that since the brake does not work by friction, there are no brake shoe surfaces to wear out, necessitating replacement, as with friction brakes.

The specific feature of an eddy current brake lies in the fact that the braking power increases with gaining relative speeds. This type of brake shows a very low torque at low speeds. Its maximum braking torque is only reached at high speeds. The eddy current brake is successfully used when the braking action is supposed to depend on the speed, respectively when a moveable mass without heat development is rapidly damped to a stop or accelerated and when a contact-free and free of wear operation and supply of energy is required. The brake is therefore very suitable for unwinding continuous material.

The eddy current brake used in the invention, that is equipped with permanent magnets, is based on magnetism created by a rotating motion, whereby the braking magnetic force increases in relation with the rotary motion. This property makes it possible to raise the shade with an even slower speed. There is an air space between the magnetic core and the copper and steel tubes around it and therefore there is no abrasive contact or friction between components. The roller shade of the invention therefore has an excellent resistance and durability.

The outer periphery of the magnetic circuit in the eddy current brake of the invention is closed with an iron and copper tube, and therefore the material of the tube that works as a shaft for the shade is not critical. In addition, it is easy to design the magnetic brake for shade tubes of different sizes by calculating the magnetic field needed by means of the peripheral speed and torque and thereby the necessary number and size of the magnets.

The invention successfully uses an eddy current brake that calculationally corresponds to the spring force of the spring mechanism so that the movement of the raising curtain is even and the created eddy currents brakes mote the more the spring strive to rotate the shade and lift it up. No electricity is needed in the invention.

In the following, the invention is described by means of some preferable embodiments to which the invention is not restricted.

### BRIEF DESCRIPTION OF THE DRAWINGS

FIG. 1 is a general presentation of a first embodiment of the roller shade of the invention, wherein there is a spring mechanism in one end of the shaft of the roller shade and an eddy current brake in other end

FIG. 2 is a general presentation of a second embodiment of the roller shade of the invention, wherein the spring mechanism and the eddy current brake are at the same end of the shaft of the roller shade

FIG. 3 is a detailed assembly illustration of the eddy current brake used in the invention in parts

FIG. 4 is a cross-section of the brake connected to the shaft of the roller shade

FIG. 5 is a detailed view of a part of FIG. 1 showing the brake and the end of the shaft of the roller shade separate from eachother

### DETAILED DESCRIPTION

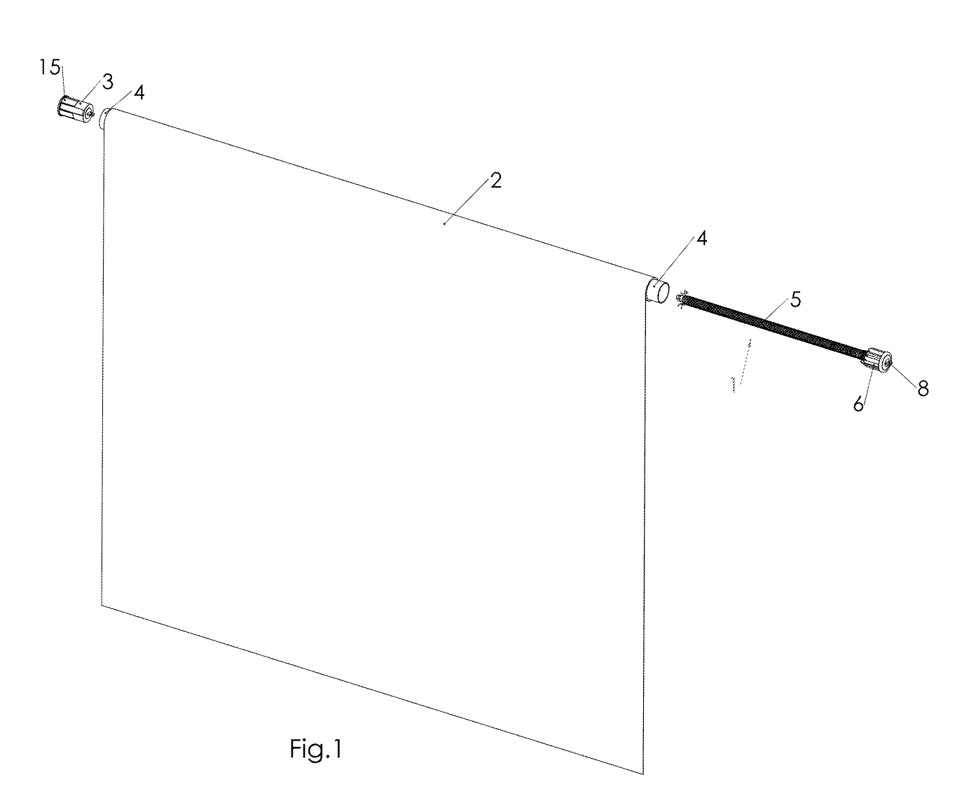

FIG. 1 presents generally a first embodiment of the roller shade of the invention. The roller shade of the invention comprises at least such components as a shade 2, a tube-like shaft 4, a spring mechanism 1 and a brake 3.

The shade 2, which term here is used to describe the fabric part of the roller shade of e.g. cotton or polyester, can be wound or rolled around the shaft 4 in an upper position and be lowered in a lowered position. In FIG. 1, the shade 2 is partly wound up. The lower edge of the shade part 2 often has a bottom bar or some handle attached directly to the bar or a cord with a tassel to facilitate the lowering (not shown).

The spring mechanism 1, which in FIG. 1 is shown separately from the roller shade, is in reality inside the shaft 4 of the shade and it includes a rod 5 around which is fitted a spiral torsion spring (cannot be seen in FIG. 1). The spring is fixed with fastening means 6 that rotates with the shaft 4 and work as a bearing. The end of the rod 5 is available at the outside of the shaft 4 in the form of a flat bar 8, which is held against rotation by means of a fixture, which is not shown.

The rotation of the shaft 4 causes a tensioning of the spring when the roller shade is pulled down. In order to lock the roller shade in a desired lower position, latching devices are fitted in the bearing part 6, which are released by pulling down the roller shade a little bit.

When the spring mechanism 1 is released by pulling down from the lower edge of the shade 2, the tension of the spring pulls up the curtain 2. The more force there is in the spring, the faster the shade 2 is lifted up. However, a brake 3 is used in the roller shade of the invention that brakes the shade 2 with increasing power along with increasing speed of the shade 2.

Thanks to the brake 3 that is used in the roller shade of the invention, which is preferably an eddy current brake and fastened to the shaft 4, a controlled release of the tensioning of the spring can be obtained. In the embodiment of FIG. 1, the spring mechanism 1 is at one end of the shaft 4 of the roller shade and the eddy current brake 3 at the other end of the shaft 4 of the roller shade.

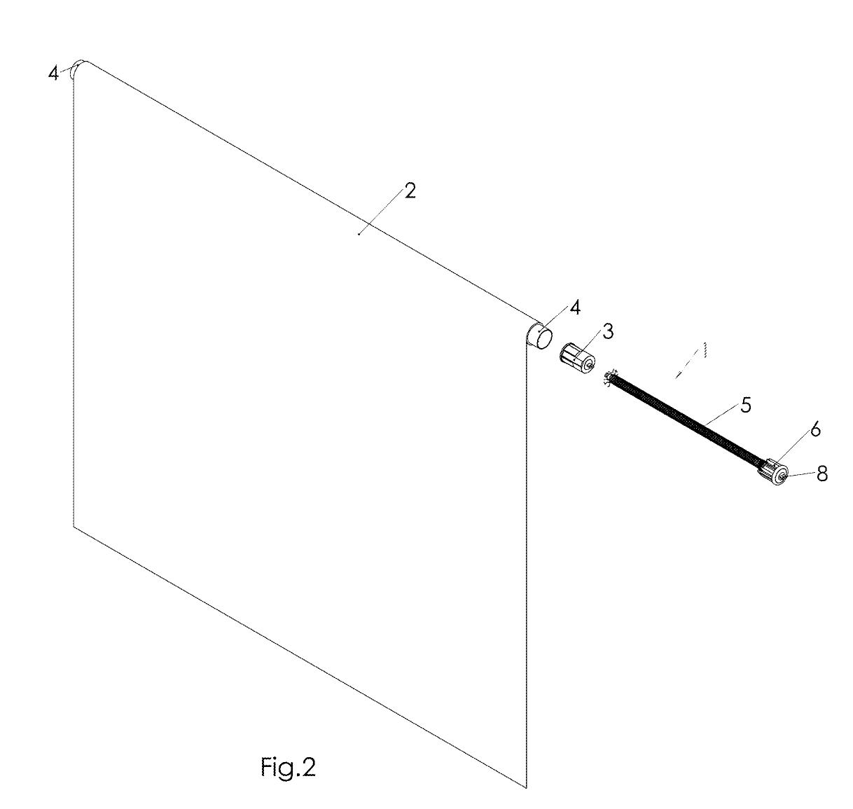

FIG. 2 presents generally a second embodiment of the roller shade of the invention, wherein the spring mechanism 1 and the eddy current brake 3 are at the same end of the shaft 4 of the roller shade.

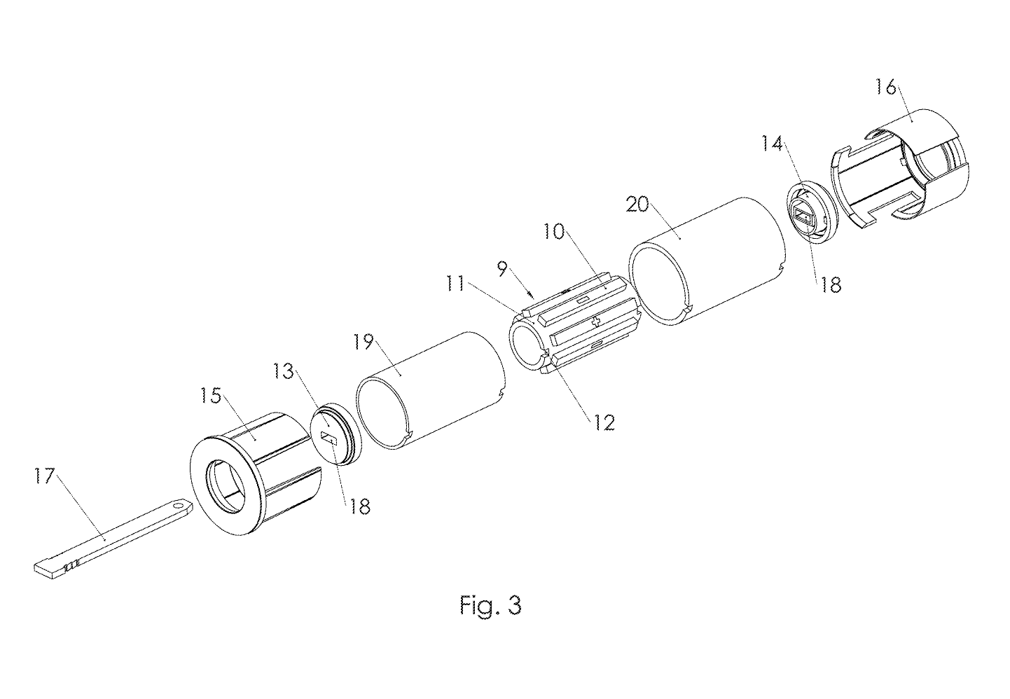

FIG. 3 is a detailed assembly illustration of the eddy current brake 3 used in the invention in parts. The eddy current brake 3 comprises a magnetic core 9 that consists of narrow perpendicularly magnetized discs 10 of permanent magnets glued around a first steel tube 11 being alternately placed with respect to their polarity (+up and down). The brake force can be adjusted by means of the length of the discs 10. The brake is more powerful the longer the discs 10 are. The magnetic force needed and the size of the magnets can be mathematically calculated when the force of the spring mechanism 1, the diameter of the shaft 4 and the desired raising speed of the shade is known.

There are slots 12 in both end of the first steel tube 11 to which round-shaped end plates 13, 14 of hard and slippery plastic can be locked. The outer periphery of these end plates 13, 14 work as bearings against the inner edge of the outer end pieces 15, 16 on both sides of the brake 3. The outer end pieces 15, 16 are also made of hard and very slippery plastic.

In the embodiment of FIG. 1, one of the end pieces 15 is bigger than the other end piece 16 because the small one 16 has to fit inside the shaft 4 of the roller shade and the other one be big enough not to go completely inside but to fit tightly against the end of the shaft to facilitate keeping the brake 3 in place. In this embodiment, a flange of the bigger end piece 15 is outside the shade 4.

In the embodiment of FIG. 2, both end pieces 15, 16 have to be small enough to fit inside the shaft 4 of the roller shade and can be similar, .i.e. they can e.g. both be like the smaller one 16.

The eddy current brake 3 further comprises a plate-like axle 17 inside the magnetic core 9 from which axle 17 one end of the eddy current brake 3 can be fastened to the wall or to the supporting member of the roller shade in the embodiment of FIG. 1. In the embodiment of FIG. 2, the axle 17 is fastened to the rod 5 of the spring mechanism 1.

The plate-like axle 17 is pushed into the magnetic core 9 through openings 18 in the end plates 13, 14.

Next, the combination of the magnetic core 9 and the end plates 13, 14 and the plate-like axle 17 is pushed inside a copper tube 19, on which copper tube 19 there is an outer second steel tube 20.

In the embodiment of FIG. 2, the diameter of the outer end pieces 15, 16 is only slightly larger than that of the outer second steel tube 20 but smaller than the shaft 4 of the roller shade so that the assembled brake 3 easily could be pushed inside the shaft 4.

In the embodiment of FIG. 1, the bigger end piece 15 has to be dimensioned so that it is very tightly and securely locked to the shaft 4 of the roller shade so that a flange of the end piece 15 is outside the shaft 4.

In practice, the magnetic core 9 itself does not rotate, since the axle 17 is locked to a supporting member of the roller shade like in FIG. 1 or to the rod 5 of the spring mechanism 1 like in FIG. 2. However, the combination of the copper tube 19 and the outer steel tube 20 around the magnetic core do rotate together with the end pieces 15 and 16 by creating eddy currents between the magnetic core 9 and the tubes 19, 20. The tubes 19 and 20 hinder the eddy currents to exit when they are correctly dimensioned.

Thus, the outer end pieces 15 and 16 forms a bearing together with the end plates 13, 14 by keeping the magnetic core 9 free from the copper tube 19 so that there is a little air space therebetween.

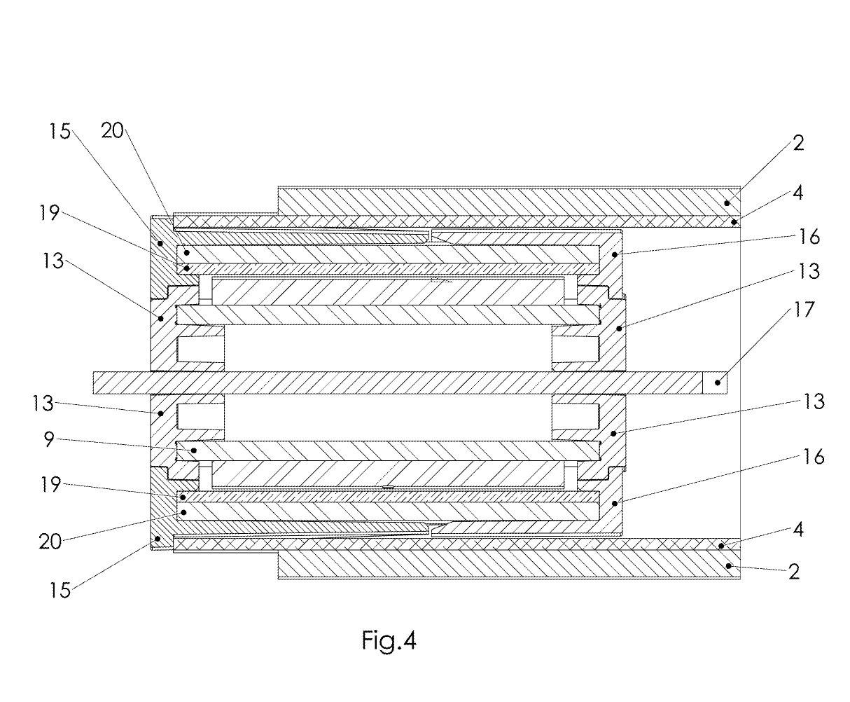

FIG. 4 is a cross-section of the brake 3 fastened to the shaft 4 of the roller shade in accordance with the embodiment of FIG. 1.

It can be seen that the brake 3 is almost completely inside the shaft 4 so that only the flange of the bigger end piece 15 stays outside. In this bigger end piece 15, there are small flexible ribs on the outer surface of the brake 3 that goes inside the tube shaft 4. The brake 3 is wedged tightly inside the shaft 4 by means of these ribs.

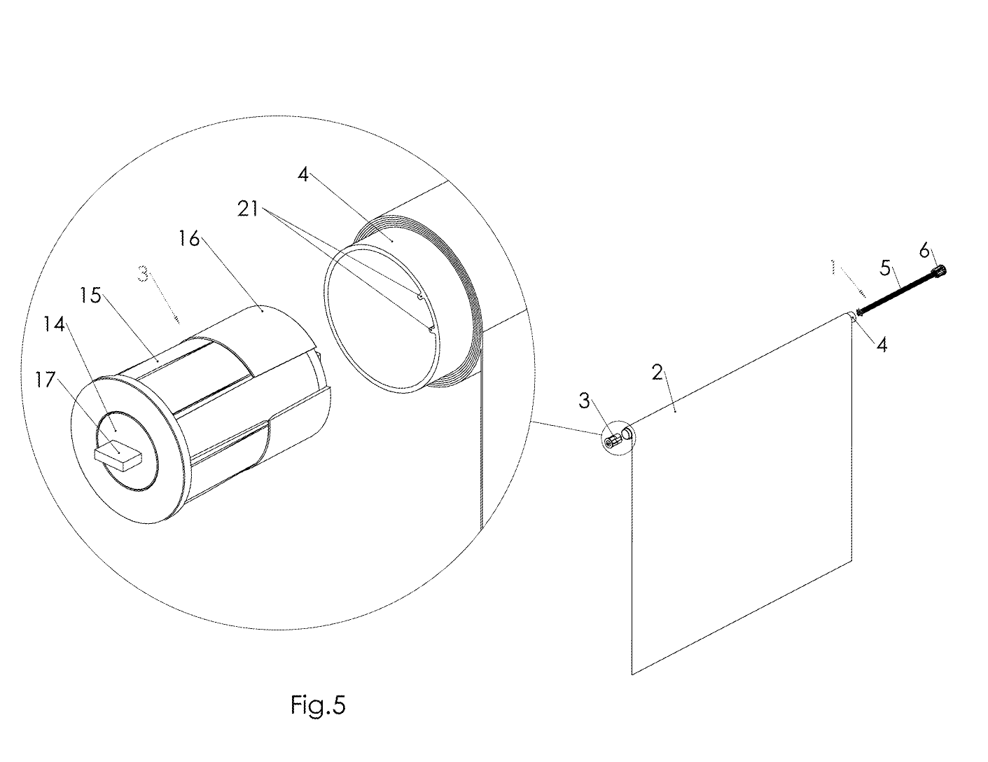

FIG. 5 is a detailed view of a part of FIG. 1 showing the brake and the end of the shaft 4 of the roller shade separate from eachother. Ribs 21 inside the shaft 4 enables a fastening between the brake 3 and the shaft 4 also in embodiments when the brake 3 is completely inside the shaft 4. In the embodiment of FIG. 5, however, one of the end pieces 16 is small and the other end piece 15 is big enough so that a flange of it stays outside the shaft 4 and tightly keeps the brake 3 in place inside the shaft 4 and having slots that corresponds to the ribs 21 inside the shaft 4. The ribs 21 cause the tubes 19 and 20 on the outer periphery of the brake 3 to rotate. Here, one end of the eddy current brake 3 is fastened to the wall or to the supporting member of the roller shade and the other end to the shaft 4 by means of a connection between the slots and the ribs.

In this embodiment, the rotation movement of the shaft 4 is transferred to the end pieces 15 and 16 of the brake 3 causing the end pieces 15 and 16 to rotate. The copper tube 19 and the outer steel tube 20 around the magnetic core 9 do rotate together with the end pieces 15 and 16 by creating eddy currents between the magnetic core 9 and the tubes 19, 20 but the magnetic core 9 itself dos not rotate, since the axle 17 is locked to a supporting member of the roller shade.

Another fastening of the brake 3 is used for the embodiment of FIG. 2. No detailed figure for this embodiment is shown. One end of the axle 17 will be attached to the end of the rod 5 of the spring mechanism 1. The brake 3 and the spring mechanism are on the same end of the shaft tube 4 and the whole brake is going inside the shaft tube 4 of the roller shade. One end of the axle 17 of the brake 3 is connected to the rod 5 of the spring mechanism 1. In this case, the outer end pieces 15 are 16 can be similar and both are small enough to fit inside the shaft tube 4. Both end pieces 15 and 16 are connected to the shaft tube 4 by a similar fastening mechanism as described above, wherein there are ribs inside the shaft tube 4 that fit into slots in the end pieces 15 and 16.

Instead of a fastening mechanism, wherein ribs and slots are used, the inside of the shaft 4 can be smooth. In such an embodiment suitable for the embodiment of FIG. 1, the inner end piece 16 inside the shaft 4 has to be so tightly fitted inside the shaft tube that it rotates with the shaft 4.

While the present invention has been described in accordance with preferred compositions and embodiments, it is to be understood that certain substitutions and alterations may be made thereto without departing from the spirit and scope of the following claims.

We claim:

1. A roller shade wrapped around a shaft, comprising:
a supporting member through which the roller shade is fastenable to a wall and with a spring mechanism, with which the roller shade is lowerable upon tensioning of an un-wrap spring connected through a rod to the shaft that rotates in a first direction at the lowering and raised upon releasing of the un-wrap spring when the shaft rotates in the opposite direction, an eddy current brake fastened to the shaft for a controlled release of the tensioning of the spring.

2. A roller shade of claim 1, wherein the eddy current brake comprises a magnetic core that consists of discs of permanent magnets around a first steel tube being alternating placed with respect to their polarity.

3. A roller shade of claim 1, wherein the eddy current brake further comprises end plates at both ends of the first steel tube, the end plates being bearings for outer end pieces.

4. A roller shade of claim 4, wherein the magnetic core, the end plates, and a part of the plate-like axle is inside a copper tube, on which copper tube there is a second steel tube.

5. A roller shade of claim 1, wherein the eddy current brake is completely inside the shaft of the roller shade.

6. A roller shade of claim 1, wherein the eddy current brake and the spring mechanism (1) are at the same end of the shaft (4) of the roller shade.

7. A roller shade of claim 5, wherein the eddy current brake comprises a plate-like axle through which one end of the eddy current brake is fastenable to the supporting member and the other end is fastened to the rod of the spring mechanism.

8. A roller shade of claim 3, wherein the eddy current brake is almost inside the shaft of the roller shade except a flange of one of the end pieces.

9. A roller shade of claim 1, wherein the eddy current brake and the spring mechanism are at opposite ends of the shaft of the roller shade.

10. A roller shade of claim 8, wherein the eddy current brake comprises a plate-like axle through which one end of the eddy current brake is fastenable to the wall or to the supporting member.

11. A roller shade of claim 8, wherein one of the end pieces of the eddy current brake is connected to the shaft of the roller shade inside the shaft.

12. A roller shade of claim 3, wherein the connection between the shaft of the roller shade and the eddy current brake is realized by ribs inside the shaft of the roller shade that fits into slots in one or both end pieces of the eddy current brake.

13. A roller shade of claim 3, wherein the connection between the shaft of the roller shade and the eddy current brake is realized by a tight contact therebetween, the inside of the shaft being smooth and the end piece that inside the shaft being tightly fitted inside the shaft and rotates with the shaft.
